(19) United States
(12) Patent Application Publication
(10) Pub. No.: US 2017/0214768 A1
(43) Pub. Date: Jul. 27, 2017

(54) MODULAR CONTENT DEPLOYMENT AND PLAYBACK CONTROL SYSTEM FOR EDUCATIONAL APPLICATION

(71) Applicant: Ooka Island Inc., Charlottetown (CA)

(72) Inventors: Jim BARBER, Charlottetown (CA); Kathleen MACPHEE, Charlottetown (CA)

(21) Appl. No.: 15/003,059

(22) Filed: Jan. 21, 2016

(51) Int. Cl. H04L 29/06; A63F 13/67; G09B 7/00; G09B 5/06; G09B 17/00

(52) U.S. Cl. CPC H04L 67/42; G09B 5/06; G09B 17/006; G09B 7/00; A63F 13/67

(57) ABSTRACT

A system for modular content deployment and control includes a client device with input and output devices, and storing: graphical background elements and corresponding background identifiers; graphical foreground elements and corresponding foreground identifiers; and audio elements and corresponding audio identifiers. The client presents, via the output device, a subset of the background elements, foreground elements, and audio elements. The system also includes a server connected to the client and storing: sequential stage records each containing a subset of the background identifiers, foreground identifiers and audio identifiers; a client profile corresponding to the client, containing an identifier of a most recent completed stage, and a performance indicator for the most recent completed stage. The server is configured to receive a request for content identifiers from the client; select, based on the client profile, a default or override stage record; and transmit the identifiers in the selected stage record to the client.

### FIELD

The specification relates generally to educational software applications, and specifically to a modular content deployment and playback control system for such software applications.

### BACKGROUND

A variety of educational software applications exist to teach students skills such as reading. Research has shown that reading skill is defined by proficiency in each of five subskills, including, for example, phonics (establishing connections between sounds and letters) and phonemic awareness (hearing, identifying and employing individual sounds, or phonemes).

While the above-mentioned subskills determine the overall reading ability of an individual, users of such applications may gain proficiency in each subskill at different rates, with some subskills being easily acquired for some users but requiring more effort for other users. Some educational applications do not account for this variability. Other applications, however, do account for such variability among their users by adapting the path a user takes through the application's subskill exercises.

Due to the number of subskills to be acquired and the number of exercises employed to teach the user each subskill, and due to the variability in subskill acquisition rates by users, adaptive applications are required to accommodate a vast number of possible paths through their subskill exercises and pacing along those paths. This can lead to inefficient use of computational resources such as data storage, bandwidth (for client-server applications) and processor cycles.

### SUMMARY

According to an aspect of the specification, a system for modular content deployment and control is provided, comprising: a client device including an output device, an input device, and a memory storing: (i) a plurality of graphical background elements and corresponding background content identifiers; (ii) a plurality of graphical foreground elements and corresponding foreground content identifiers; and (iii) a plurality of audio elements and corresponding audio content identifiers; the client device further including a client processor configured to control the output device to present a subset of the graphical background elements, graphical foreground elements, and audio elements; a server connected to the client device via a network and including a memory storing: (i) a plurality of stage records arranged in a sequence, each stage record containing a respective subset of the background content identifiers, the foreground content identifiers and the audio content identifiers; (ii) a client profile corresponding to the client device, the client profile containing an identifier of a most recent completed one of the stages, and a performance indicator for the most recent completed stage; the server further including a server processor configured to: receive a request for content identifiers from the client device; responsive to receiving the request, select, based on the client profile, one of a default stage record and an override stage record from the plurality of stage records; and transmit to the client device, via the network, the subset of background content identifiers, foreground content identifiers and audio content identifiers contained in the selected stage record.

### BRIEF DESCRIPTIONS OF THE DRAWINGS

Embodiments are described with reference to the following figures, in which:

FIG. 1 depicts a system for modular content deployment and control, according to a non-limiting embodiment;

FIG. 2 depicts certain internal components of the control server and client device of FIG. 1, according to a non-limiting embodiment;

FIG. 3 depicts examples of the content data stored in the client device of FIG. 2, according to a non-limiting embodiment;

FIG. 4 depicts presentation of selected elements of the content of FIG. 3, according to a non-limiting embodiment;

FIG. 5 depicts a method of content deployment and playback control in the system of FIG. 1, according to a non-limiting embodiment;

FIG. 6 depicts a schematic of the interactions between applications in the system of FIG. 1, according to a non-limiting embodiment; and

FIG. 7 depicts a redirection routine for the method of FIG. 5, according to a non-limiting embodiment.

### DETAILED DESCRIPTION OF THE EMBODIMENTS

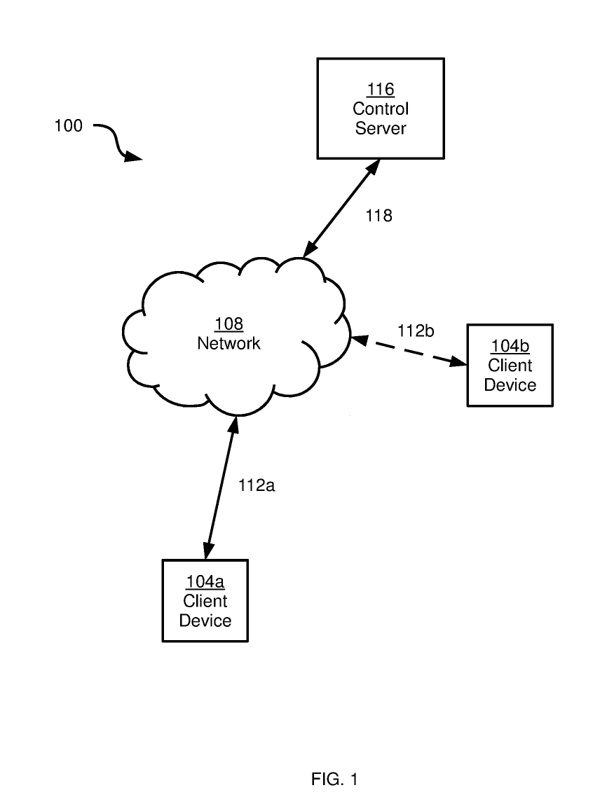

FIG. 1 depicts a system 100 for modular content deployment and playback control. System 100 includes at least one client computing device, of which two examples 104a and 104b are shown (referred to generically as a client computing device 104 or client device 104, and collectively as client computing devices 104 or client devices 104). Additional client devices (not shown) can be included in system 100. Each client device 104 can be any of a cellular phone, a smart phone, a tablet computer, a desktop computer, a laptop computer, smart television, gaming console, virtual reality computing device, and the like.

Client devices 104a and 104b are connected to a network 108 via respective links 112a and 112b, of which link 112a is illustrated as a wired link and link 112b is illustrated as a wireless link. Each of links 112, however, can be any one of, or any suitable combination of, wired and wireless links. Network 108 can include any suitable combination of wired and wireless networks, including but not limited to a Wide Area Network (WAN) such as the Internet, a Local Area Network (LAN) such as a corporate data network, WiFi networks, cell phone networks (e.g. LTE) and the like.

Via network 108, client devices 104 communicate with a control server 116 connected to network 108 via a link 118 (which in the present embodiment is illustrated as a wired link, but can be any one of, or any suitable combination of, wired and wireless links). Control server 116 provides a content playback control service to client devices 104. As will be described in detail below, each client device 104 stores data defining a plurality of content elements (e.g. images, audio files and the like). Server 116 operates to instruct each client device 104 which of those content elements to present to the operators of client devices 104 at a given time. Server 116 also receives reporting data from client devices 104, and processes the reporting data to determine which content to instruct client devices 104 to present.

More specifically, in the embodiments described herein, the content stored by each client device 104 represents an educational software application, directed to teaching the operator of each client device 104 (e.g. a child) to read. The content elements stored at each client device 104 thus include images and sounds corresponding to phonemes, syllables, words and the like, employed in teaching the operator to read. Server 116, as will be seen below, instructs client devices 104 as to which combinations of the above-mentioned content to present to the operator at any given time, based on processing activities performed at server 116. Thus, as will become apparent herein, storage-intensive content data resides at client devices 104 (rather than traversing network 108 during playback), while processing for the selection of content to present to an operator (which may be computationally intensive, subject to more frequent reconfigurations than the content itself, or both) occurs at server 116 and traverses network 108.

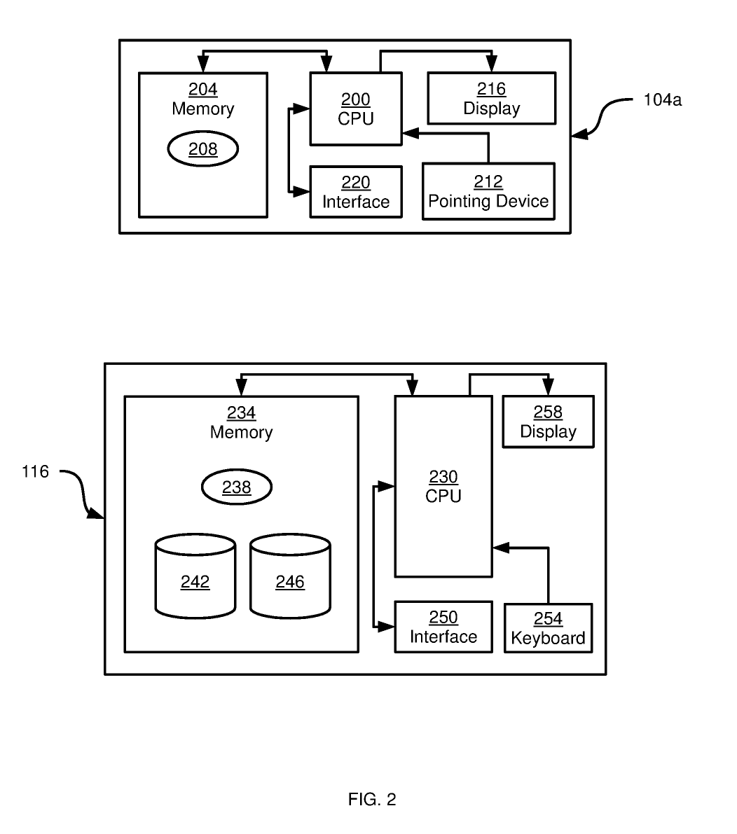

Before a detailed discussion of the operation of system 100 is provided, certain components of client devices 104 and control server 116 will be described with reference to FIG. 2.

Referring now to FIG. 2, client device 104a (the discussion below also applies to client device 104b, and any other client devices) includes a central processing unit (CPU) 200, also referred to herein as processor 200, interconnected with a memory 204. Memory 204 stores computer readable instructions executable by processor 200, including an educational application 208, whose contents will be discussed in greater detail further below. Processor 200 and memory 204 are generally comprised of one or more integrated circuits (ICs), and can have a variety of structures, as will now occur to those skilled in the art (for example, more than one CPU can be provided).

Processor 200 executes the instructions of educational application 208 to perform, in conjunction with the other components of client device 104a, various functions related to presenting content contained in educational application 208, under the guidance of control server 116. In the below discussion of those functions, client device 104a is said to be configured to perform those functions—it will be understood that client device 104a is so configured via the processing of the instructions in application 208 by the hardware components of client device 104a (including processor 200 and memory 204).

Client device 104a also includes at least one input device interconnected with processor 200, in the form of a pointing device 212. Pointing device 212 can include any suitable one of, or combination of, input devices. For example, pointing device 212 can a mouse, a touch screen or the like. In further embodiments, client device 104 can include additional input devices, such as a keyboard, a microphone, a camera, a GPS receiver, and the like (not shown). Client device 104a also includes at least one output device interconnected with processor 200, including a display 216. When pointing device 212 includes a touch screen, display 216 and pointing device 212 can be integrated with one another. Other output devices can also be provided, such as a speaker (not shown). Client device 104a also includes a network interface 220 interconnected with processor 200, which allows client device 104a to connect to network 108 via link 112a. Network interface 220 thus includes the necessary hardware, such as radio transmitter/receiver units, network interface controllers and the like, to communicate over link 112a.

Control server 116 includes a central processing unit (CPU) 230, also referred to herein as processor 230, interconnected with a memory 234. Memory 234 stores computer readable instructions executable by processor 230, including a control application 238. Processor 230 and memory 234 are generally comprised of one or more integrated circuits (ICs), and can have a variety of structures, as will now occur to those skilled in the art (for example, more than one CPU can be provided). Processor 230 executes the instructions of control application 238 to perform, in conjunction with the other components of control server 116, various functions related to instructing client devices 104 to present content from their respective educational applications 208. In the discussion below of those functions, control server 116 is said to be configured to perform those functions—it will be understood that control server 116 is so configured via the processing of the instructions in application 238 by the hardware components of control server 116 (including processor 230 and memory 234).

Memory 234 also stores a sequence database 242, which contains records defining a plurality of content stages for the content of application 208, as will be discussed below. Also stored in memory 234 is a client profile database 246, which contains profile data corresponding to each client device 104 (e.g. an identifier of the client device 104 and various other data to be discussed below). Although databases 242 and 246 are discussed below as two distinct databases, in some embodiments they can be implemented in a single database, or in a greater number of databases than two.

Control server 116 also includes a network interface 250 interconnected with processor 230, which allows control server 116 to connect to network 108 via link 118. Network interface 250 thus includes the necessary hardware, such as network interface controllers and the like, to communicate over link 118. Control server 116 also includes input devices interconnected with processor 230, such as a keyboard 254, as well as output devices interconnected with processor 230, such as a display 258. Other input and output devices (e.g. a mouse, speakers) can also be connected to processor 230. In some embodiments (not shown), keyboard 254 and display 258 can be connected to processor 230 via network 108 and another computing device. In other words, keyboard 254 and display 258 can be local (as shown in FIG. 2) or remote.

As will be described in greater detail below, at predefined points in the execution of application 208, each client device 104 is configured to request instructions from server 116 as to which content from application 208 to present to the operator of the client device. Server 116, in response, is configured to select content identifiers from sequence database 242 based on the relevant profile from database 246, and to return the selected content identifiers to the client device 104. In selecting content identifiers, server 116 is generally configured to determine whether to select default content identifiers or override content identifiers, based on the relevant client profile.

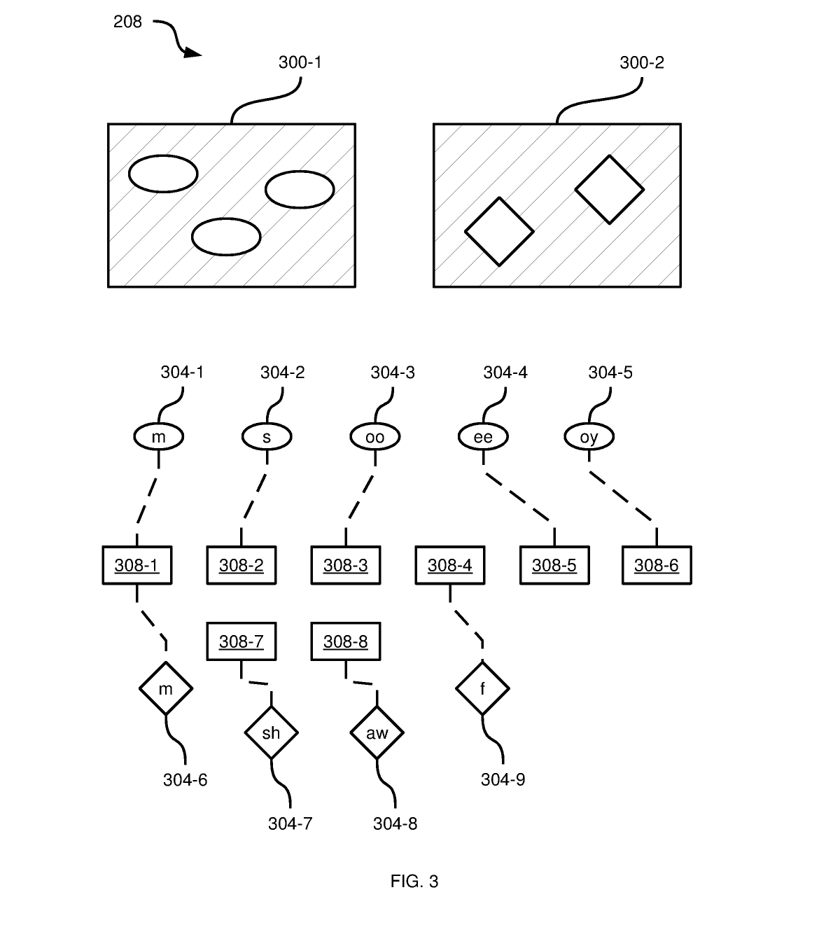

Turning now to FIG. 3, examples of content elements stored in application 208 are illustrated. In particular, application 208 includes a plurality of background graphical elements, of which two examples 300-1 and 300-2 are shown. The nature of background graphical elements 300 is not particularly limited. For example, background graphical elements 300 may be static two-dimensional images, as illustrated in FIG. 3. In other embodiments, however, background graphical elements can represent virtually navigable three-dimensional environments (i.e. game worlds or areas). Thus, background graphical elements 300 can each include a plurality of files—the data structure employed to store background graphical elements 300 is not particularly limited, and may be selected by the skilled person based on the complexity of the environment to be simulated by application 208.

Each background graphical element corresponds to a background content identifier also contained in application 208. In the present discussion, the identifiers 300-1 and 300-2 introduced above are assumed to be stored in application 208 in correspondence with their respective background graphical elements. A wide variety of other identifiers may also be employed, however.

In addition, application 208 includes a plurality of foreground graphical elements, of which nine examples 304-1, 304-2, 304-3, 304-4, 304-4, 304-6, 304-7, 304-8 and 304-9 are shown in FIG. 3. Each foreground graphical element 304 corresponds to a foreground content identifier, which in the present discussion is assumed for the sake of illustration to be the 304-series identifiers introduced above. As illustrated, foreground graphical elements 304 each display a sound in the English language. However, a wide variety of other foreground graphical elements are also contemplated in the context of educational application 208. For example, other foreground graphical elements 304 can display syllables, words, combinations of words, and the like.

Further, application 208 includes a plurality of audio elements, of which six examples 308-1, 308-2, 308-3, 308-4, 308-5, 308-6, 308-7 and 308-8 are shown in FIG. 3. Each audio element 308 can be, for example, a sound file. Like the background and foreground graphical elements, the audio elements also each have a corresponding audio identifier stored in application 208; also like the graphical elements described above, in the present discussion the audio identifiers are taken to be the 308-series numerals introduced above.

As shown by the dashed lines in FIG. 3, the audio elements 308 can correspond to the graphical foreground elements 304. That is, each audio element 308 can consist of an audio file representing the pronunciation of the sound illustrated by one of more graphical foreground elements 304. It is not necessary that every audio element 308 correspond to a graphical foreground element 304, or that every graphical foreground element 304 correspond to an audio element 308. In the present embodiment, the correspondences between graphical foreground elements 304 and audio elements 308 are stored within application 208. In other embodiments, however, application 208 need not contain any indication of which audio elements match which graphical elements (in which case application 208 requires instruction from server 116 to establish such matches).

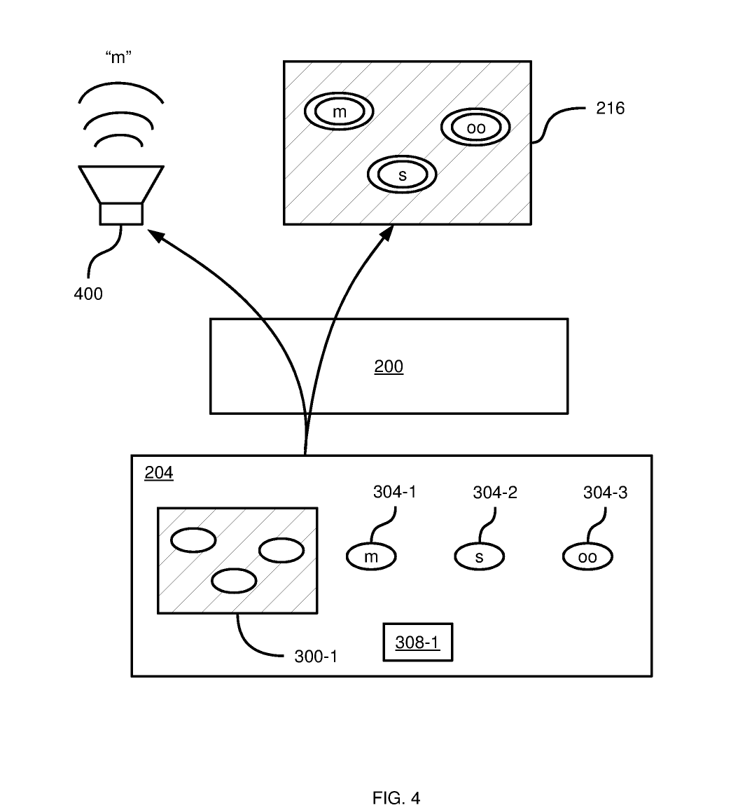

Turning to FIG. 4, an example of content playback at client device 104a is illustrated. In general, processor 200 is configured to retrieve a subset of the above-mentioned content elements—typically one graphical background element and a plurality of graphical foreground elements and audio elements—from memory 204, and to control the output devices of client device 104 to present the selected content. For example, as shown in FIG. 4, graphical background element 300-1, graphical foreground elements 304-1, 304-2 and 304-3, as well as audio element 308-1, are retrieved from memory 204 and sent to display 216 as well as a speaker 400 for output (i.e. presentation to the operator of client device 104a).

Processor 200 is also configured, via execution of application 208, to receive input data. For example, the content presented in FIG. 4 may instruct the operator of client device 10 to select the graphical foreground element that corresponds to one of a plurality of sounds corresponding to the foreground elements (currently the “m” sound) played by speaker 400. Such prompts can be defined in application 208, and particularly in the graphical background elements. The operator may then, using pointing device 212, select one of the graphical foreground elements shown on display 216. The selection is received from pointing device 112 at processor 200 as input data.

Processor 200, via the execution of application 208, can evaluate input received (e.g. from pointing device 112) to determine if the input is correct, according to evaluation rules which may be stored within the active graphical background element or elsewhere in application 208.

Thus, application 208 contains various graphical and audio data, and enables client device 104a to present such content, receive input data associated with the content, and evaluate the input data. However, application 208 does not enable client device 104a to determine which content to present. In other words, application 208 preferably does not contain associations between graphical background elements 300 and graphical foreground elements 304 and their corresponding audio elements 308. The selection of content to present is performed by server 116, as will be discussed below.

As noted earlier, server 116 stores sequence database 242 and client profile database 246. Sequence database 242 stores a plurality of stage records arranged in a sequence. Each stage record contains a subset of the above-mentioned background content identifiers, foreground content identifiers and audio content identifiers. The stage records need not contain the actual content, however (that is, the graphical and audio elements described above). An example of database 242 is shown below in Table 1:

TABLE 1
Example Sequence Database 242

| Skill Level | Game Area 1 | Game Area 2 |
|---|---|---|
| 1 | Background: 300-1 | Background: 300-2 |
| | Foreground/Audio: 304-1, | Foreground/Audio: 304-6, 304-7 |
| | 304-2, 304-3 | Sessions required: 3 |
| | Sessions required: 3 | |
| 2 | Background: 300-1 | Background: 300-2 |
| | Foreground/Audio: 304-3, | Foreground/Audio: 304-8, 304-9 |
| | 304-4, 304-5 | Sessions required: 3 |
| | Sessions required: 3 | |

As seen in the example above, database 242 defines four sequential stages, each of which represents a combination of a game area in application 208 and a skill level (a reading skill level, specifically). The contents of database 242 can be stored in a variety of formats beyond the tabular format shown above. In general, each stage record (i.e. each of the four cells in the above table) identifies a subset of the content stored in application 208. As will now be apparent, the top-left cell corresponds to the content presented in FIG. 4. A wide variety of other stages may also be defined in database 242. In Table 1, the sequence of the stages is not implicit rather than explicitly defined: the sequence of stages begins at the top-left cell and ends at the bottom-right cell (i.e. skill level 1 and game area 1; skill level 1 and game area 2; skill level 2 and game area 1; and finally, skill level 2 and game area 2). In other embodiments, sequence numbers can be explicitly stored within each stage record.

In general, each stage specifies a graphical background element, which defines the visual environment to be presented to the operator of client device 104a. The background also sets the scope of the operator's interaction with client device 104a. For example, background element 300-1 leads to a presentation of content in which the operator must select the correct foreground element corresponding to a sound played via speaker 400. Background 300-2 may, for example, lead to a presentation of content in which the operator must select the displayed foreground elements in sequence, in response to which client device 104a plays the sounds corresponding to those foreground elements.

Database 242 may also, for each stage, specify a number of sessions that are required for each stage to be completed (that is, for client device 104a to advance to the next stage). A session is a single playthrough of the stage; distinct sessions may be separated in time (i.e. through multiple launches of application 208), or may be substantially adjacent in time (following a single launch of application 208).

In other words, database 242 defines which content is to be presented by client devices 104 at any given time (information which, as noted earlier, client devices 104 themselves preferably do not store). Database 242 is one collection of data that server 116 processes when selecting content identifiers to transmit to a client device 104. Another collection of data processed by server 116 is client profile database 246, an example of which is shown below in Table 2:

TABLE 2
Example Client Profile Database 246

| | Client Device 104a | Client Device 104b |
|---|---|---|
| Username | 104a | . . . |
| Password | ******** | . . . |
| Stage 1 scores | N/A | . . . |
| Stage 1 repeat score | N/A | . . . |
| Stage 1 remedial | N/A | . . . |
| Stage 2 scores | N/A | . . . |
| Stage 2 repeat score | N/A | . . . |
| Stage 2 remedial | N/A | . . . |
| Stage 3 scores | N/A | . . . |
| Stage 3 repeat score | N/A | . . . |
| Stage 3 remedial | N/A | . . . |
| Stage 4 scores | N/A | . . . |
| Stage 4 repeat score | N/A | . . . |
| Stage 4 remedial | N/A | . . . |

As seen above, profile database 246 contains a profile record corresponding to each client device 104. In some embodiments, profile records need not be tied to specific hardware (that is, to specific client devices)—a given profile can be associated with a plurality of client devices 104. However, for the sake of simplicity it is assumed herein that each profile is accessed from only one client device 104.

Each client profile includes authentication data, such as a username and password. Each client profile also includes performance data corresponding to each of the stages defined in database 242. In the example above, the performance data is empty, as it is assumed that client device 104a has not yet executed application 208. Client profiles can also store data reported from the corresponding client device 104, as will be discussed below in greater detail. Such data is not shown above in Table 2, however.

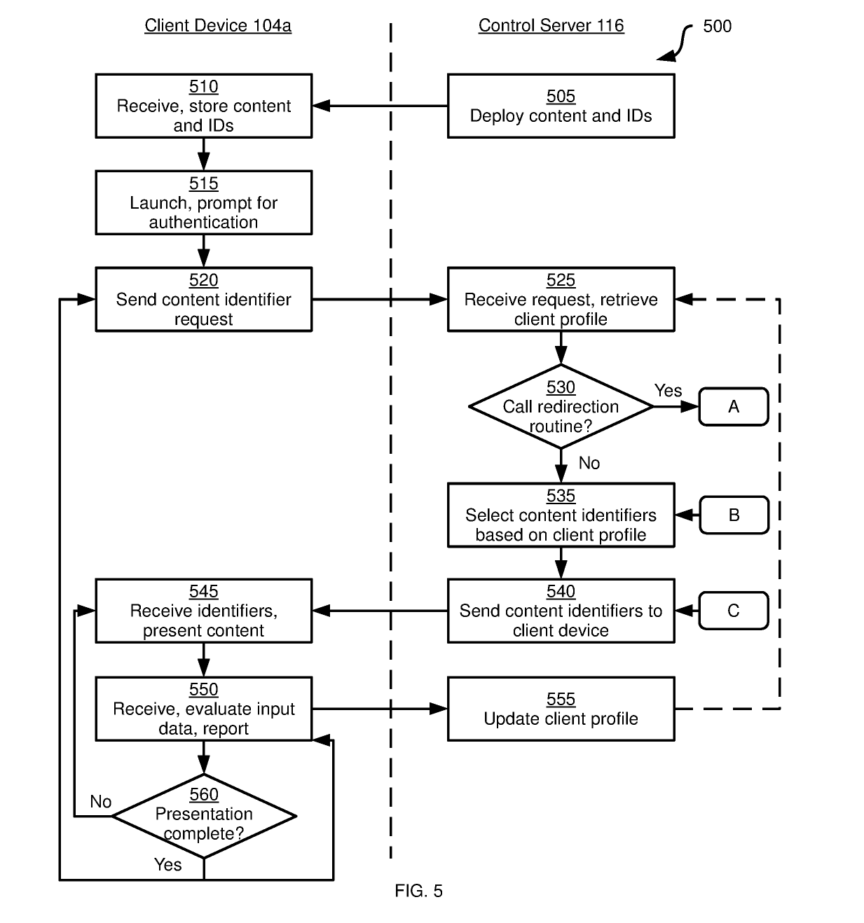

Turning now to FIG. 5, a method 500 of content deployment and playback control is illustrated. Method 500 will be described in conjunction with its performance by system 100. Specifically, as illustrated in FIG. 5, certain blocks of method 500 are performed by client device 104a via the execution of application 208, while others are performed by control server 116 via the execution of application 238.

Beginning at block 505, control server 505 can be configured to deploy the content and corresponding content identifiers to client device 104a. The deployment can occur by retrieving the content and identifiers from memory 234 and transmitting them to client device 104a via network 108. In other embodiments, server 116 can be involved in content deployment only indirectly, or not at all. For example, deployment can occur by the transport of physical media (e.g. a DVD or other physical storage media) containing the content and identifiers to client device 104a.

At block 510, having received the content and identifiers (that is, having received application 208), regardless of the source of such receipt, client device 104a is configured to store the content and identifiers in memory 204. At block 515, for example in response to input data instructing processor 200 to begin execution of application 208, client device 104a is configured to launch (that is, begin executing) application 208, which causes client device 104a to prompt the operator of client device 104a for authentication information. In the present embodiment, the authentication information is the username and password shown above in Table 2. Any other suitable form of authentication may also be implemented, however (e.g. biometrics, external storage media containing authentication data, and the like). Having received authentication information as input data, client device 104a can be configured to complete an authentication process with server 116 prior to advancing to the next block of method 500, or can transmit the authentication data to server 116 simultaneously with the next block. In any event, it will be assumed in the discussion below that authentication is successful, as failed authentication handling may be implemented in a variety of known ways, and is not relevant to the discussion herein.

At block 520, client device 104a is configured to send a request for content identifiers to control server 116, via network 108. As noted above, although client device 104a stores the graphical background and foreground elements, as well as the audio elements, client device 104a preferably does not store data defining which of the content elements to present at any given time. Thus, at various points during the execution of application 208 (including at launch), client device 104a requests such data from server 116. The request includes at least an identifier of client device 104a, such as the username shown above.

At block 525, server 116 receives the request from client device 104a, and responsive to the request, retrieves a client profile from database 246 according to the identifier contained in the request. In the present example, therefore, server 116 is configured to retrieve the profile corresponding to client device 104a at block 525.

At block 530, having retrieved the appropriate client profile from database 246, server 116 is configured to determine whether to call a redirection routine. The redirection routine can be a component of application 238, or can be a separate application also stored in memory 234 for execution by processor 230. The operation of the redirection routine itself will be described in detail further below; in general, the redirection routine serves to override the default sequence (shown in Table 1) under certain conditions. The determination at block 530 can be made on a variety of factors, or on combinations of those factors. In some simplified embodiments, server 116 can be configured to simply call the redirection routine at every performance of block 530 (that is, the determination is always affirmative). In other embodiments, server 116 can be configured to call the redirection routine only when the most recently presented stage of content at client device 104a (as indicated by the presence of scores in Table 2) is one of a predefined list of redirection-eligible stages stored in memory 234.

In the present embodiment, server 116 is configured to determine at block 530 whether the number of sessions for the most recently completed stage of content matches the required number of sessions specified in database 242 for that stage. As seen in Table 2, no sessions of any stage have been played at client device 104a, and therefore the determination at block 530 is negative.

Following a negative determination at block 530, server 116 proceeds to block 535, and selects content identifiers from database 242 based on the client profile retrieved at block 525. The content identifiers selected from database 242 define a stage of content. Due to the negative determination at block 530, the present selection of content identifiers corresponds to the selection of a “default” stage (when the redirection routine is called, as will be discussed below, it may result in the selection of an override stage).

Server 116 is configured to select the stage from database 242 that follows (in the sequence defined in database 242) the most recently completed stage as indicated in the client profile retrieved at block 525. In the present example performance of method 500, Table 2 illustrates that no stages have been completed yet (no session scores are present for any of the stages in Table 2), and therefore, at block 535 server 116 is configured to select the first stage record in the sequence defined in database 242.

At block 540, having selected content identifiers, server 116 is configured to send the selected content identifiers to client device 104a via network 108. At block 545, client device 104a receives the content identifiers, and presents the corresponding content. In the present example, at block 545 client device 104a therefore receives a message from server 116 that includes the content identifiers defining stage 1 (skill level 1 and game area 1). As a result, client device 104a retrieves and presents graphical background element 300-1, as well as graphical foreground elements 304-1, 304-2, and 304-3 and their corresponding audio elements (which can be explicitly identified in the message from server 116, but need not be if the correspondence between graphical foreground elements 304 and audio elements 308 was previously stored in application 208).

The presentation of content at block 545 is as described above in connection with FIG. 4, and indeed, FIG. 4 illustrates the content corresponding to the first stage identifiers received from server 116 at block 545. Via the execution of application 208, client device 104a can be configured to repeat the content presentation a configurable number of times (that is, to ask the operator of client device 104a a plurality of “questions”), varying the audio file that is played with each repetition and, when there are sufficient graphical foreground elements in the stage (that is, more graphical foreground elements than there are spaces for them in background elements 300-1), also varying which subset of the foreground elements are presented for each question. In other words, client device 104a is configured to persistently present the relevant graphical background element, and to present at least a portion of the relevant graphical foreground elements and audio elements, wait for operator input, and then present a further portion (which may be different) of the relevant foreground and audio elements.

At block 550, throughout the presentation of content, client device 104a is configured to receive and evaluate input data, for instance via pointing device 212. As mentioned earlier, the “stage 1” content requires the operator of client device 104a to listen to a sound played by speaker 400, and select the one of the foreground elements presented on display 216 that corresponds to the sound. Such selection is received at processor 200 from an input device such as pointing device 212. Upon receipt of input data representing a selection, processor 200 is configured to determine whether the selection was correct (i.e. whether the selected foreground element 304 matched the audio element 308 played by speaker 400). Having determined whether the “answer” was correct, client device 104a is configured to report the answer to server 116. The report includes an identifier of the currently presented content, as well as the selected foreground element and an indication of whether the selection was correct or incorrect. Additional data can also be included in the report, such as an indication of the correct answer, and/or one or more timestamps. As will be seen below, client device 104a can provide a first timestamp corresponding to the start of the audio element playback and a second timestamp corresponding to the receipt of a selection via pointing device 212.

At block 555, server 116 is configured to receive the reported data from client device 104a, and to update the corresponding client profile in database 246. In some embodiments, server 116 can be configured to store any portion of the reported data in the client profile, including every item of reported data (that is, including every mouse click or other input action reported by client device 104a). In other embodiments, server 116 can process the reported data and store the processed data in addition to, or instead of, the raw reported data. Among the processing activities performed by server 116 is a scoring process. Server 116 is configured to determine, based on the reported data, a performance indicator (also referred to as a score) for each play session of each content stage. The score may be determined only upon completion of a session of the stage in some embodiments, or a partial score may be determined for each answer provided by client device 104a. The nature of the score calculation is not particularly limited. For example, server 116 can assign a value (such as a number of points) to each answer based on whether the answer was correct and how quickly the answer was provided by the operator of client device 104a (based on the elapsed time between the playing of the audio element and the receipt of the answer at client device 104a).

At block 560 client device 104a is also configured to determine, for example after each answer is received as input data, whether the presentation of content is complete. For example, application 208 can configure client device 104a to update a question counter after each audio file playback, or after each received answer. Client device 104a can compare the counter to a completion threshold (e.g. a number of total questions, or a number of correct answers, or a combination thereof), and when the counter reaches the completion threshold, the determination at block 560 is affirmative. Otherwise, the determination at block 560 is negative, and the presentation of content, and reporting of input data, continues. In other embodiments, the determination at block 560 can be time-based instead of, or in addition to, the factors noted above. For example, client device 104a can be configured to make an affirmative determination if the total execution time for application 208 (for a single launch) has exceeded a threshold (e.g. twenty minutes). Thresholds evaluated at block 560 can be preconfigured within application 208, or can be provided to client device 104a by server 116 along with the content identifiers received at block 545. For example, server 116 can instruct client device 104a as to which content to present, and also as to the time period for which the content should be presented. In such embodiments, the selection of content identifiers at block 535 can include the selection of a time period associated with the content identifiers (e.g. based on the client profile, including indications of completion times for previous stages, scores for previous stages and the like).

When the determination at block 560 is affirmative, client device 104a sends a further report to server 116 indicating that the presentation of content whose identifiers were most recently received from server 116 is complete. Client device 104a then returns to block 520, and requests further content identifiers.

At block 555, following the receipt of the completion report from client device 104a, server 116 is configured to update the corresponding client profile, for example to complete the performance indicator for the relevant stage. Following the performance of block 555, database 246 may be updated as shown below in Table 3:

TABLE 3
Updated Client Profile Database 246

| | Client Device 104a | Client Device 104b |
|---|---|---|
| Username | 104a | . . . |
| Password | ******** | . . . |
| Stage 1 scores | 65% | . . . |
| Stage 1 repeat score | N/A | . . . |
| Stage 1 remedial | N/A | . . . |
| Stage 2 scores | N/A | . . . |
| Stage 2 repeat score | N/A | . . . |
| Stage 2 remedial | N/A | . . . |
| Stage 3 scores | N/A | . . . |
| Stage 3 repeat score | N/A | . . . |
| Stage 3 remedial | N/A | . . . |
| Stage 4 scores | N/A | . . . |
| Stage 4 repeat score | N/A | . . . |
| Stage 4 remedial | N/A | . . . |

As seen above, one session score for the first content stage is present in database 246. Through further performances of blocks 520-560, it will be assumed that database 246 is further updated as shown in Table 4:

TABLE 4
Updated Client Profile Database 246

| | Client Device 104a | Client Device 104b |
|---|---|---|
| Username | 104a | . . . |
| Password | ******** | . . . |
| Stage 1 scores | 65%; 70%; 72% | . . . |
| Stage 1 repeat score | N/A | . . . |
| Stage 1 remedial | N/A | . . . |
| Stage 2 scores | N/A | . . . |
| Stage 2 repeat score | N/A | . . . |
| Stage 2 remedial | N/A | . . . |
| Stage 3 scores | N/A | . . . |
| Stage 3 repeat score | N/A | . . . |
| Stage 3 remedial | N/A | . . . |
| Stage 4 scores | N/A | . . . |
| Stage 4 repeat score | N/A | . . . |
| Stage 4 remedial | N/A | . . . |

As seen above, three session scores are now present in database 246 for the stage 1 content, as a result of client device 104a having been provided with the stage 1 content identifiers, and having completed presentation of the corresponding content, three times. As shown in Table 1, database 242 at server 116 requires each stage to be completed three times before advancing to the next stage, and also before calling the redirection routine.

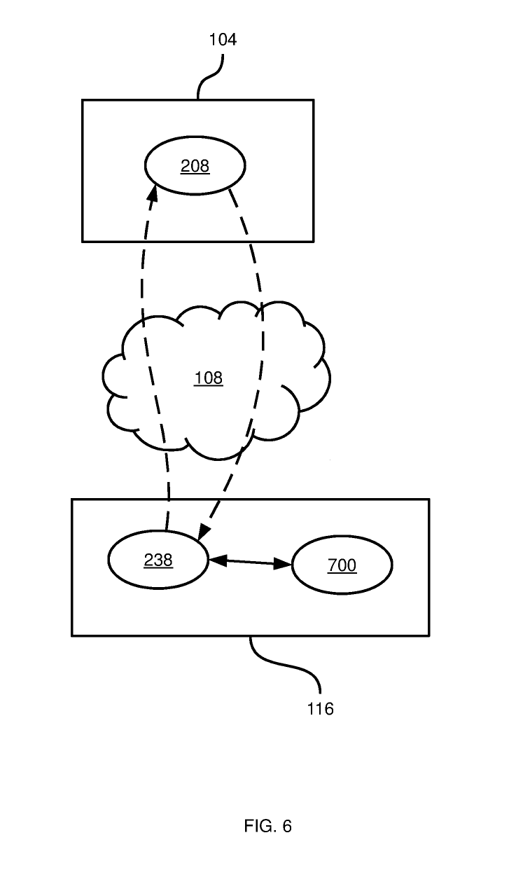

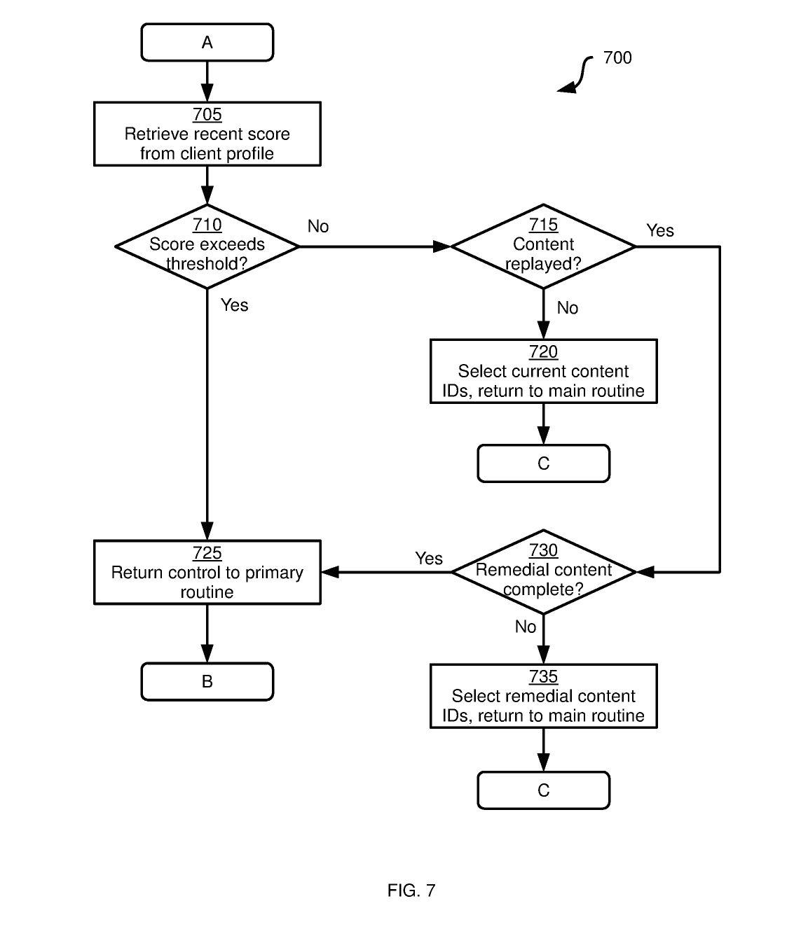

Thus, at the next performance of block 530, the determination is affirmative, and rather than proceed to block 535, server 116 is configured to execute an additional component of application 238, or a separate application stored in memory 234. Referring briefly to FIG. 7, an illustration of the operation of the redirection routine is provided. Specifically, application 208 is shown at client device 104a, and application 238 is shown at server 116. In addition, a redirection application (which may also be integrated into application 238) is shown in communication with application 238 within server 116. It is presently contemplated that redirection routine 700 does not communicate directly with application 208, but rather communicates solely with application 238. As will now be apparent, the architecture shown in FIG. 6 permits a variety of ancillary routines to be triggered from the primary routine represented by method 600, without requiring updates to application 208.

Turning to FIG. 7, a method 700 is shown illustrating the operation of the redirection routine at server 116. Method 500 will be described in conjunction with its performance by system 100, and specifically by control server 116 via the execution of application 238 or a separate application.

At block 705 (at which server 116 arrives following an affirmative determination at block 530), server 116 is configured to retrieve the most recent completed session score from the client profile retrieved at block 525. In the present example, that score is for the third session, and has a value of 72%. It is contemplated that the scores need not be percentages—any of a wide variety of scoring notations may be employed.

At block 710, server 116 is configured to determine whether the score retrieved at block 705 exceeds a predefined threshold. In the present example, the threshold is 75%, although it will now be apparent that application 238 (or, if the redirection routine of method 700 is provided by a distinct application, then that application) can be configured with any of a wide variety of thresholds. As seen in Table 4, the most recent session score is 72%, which does not exceed the threshold. The performance of method 700 therefore proceeds to block 715.

At block 715, server 116 is configured to determine whether the content corresponding to the score retrieved at block 705 has already been replayed. The determination at block 715 consists of examining the client profile for a replay score corresponding to the most recently completed content. As seen in Table 4, there is no replay score for stage 1 content, indicating that no replay has occurred. The determination at block 715 is therefore negative, and the performance of method 700 proceeds to block 720.

At block 720, server 116 is configured to select the current (that is, most recently completed) content identifiers, and return control to the primary routine depicted in FIG. 5. More specifically, as seen in FIG. 5, block 720 returns control to block 540, which bypasses the default content identifier selection of block 535. In other words, method 700 overrides the content selection process of method 500.

Server 116 is configured, following the receipt of an override stage selection, transmits the content identifiers to client device 104a at block 540. Client device 104a presents the corresponding content as described above, with the eventual result of a further update to database 246, as shown in Table 5 below.

TABLE 5
Updated Client Profile Database 246

| | Client Device 104a | Client Device 104b |
|---|---|---|
| Username | 104a | . . . |
| Password | ******** | . . . |
| Stage 1 scores | 65%; 70%; 72% | . . . |
| Stage 1 repeat score | 81% | . . . |
| Stage 1 remedial | N/A | . . . |
| Stage 2 scores | N/A | . . . |
| Stage 2 repeat score | N/A | . . . |
| Stage 2 remedial | N/A | . . . |
| Stage 3 scores | N/A | . . . |
| Stage 3 repeat score | N/A | . . . |
| Stage 3 remedial | N/A | . . . |
| Stage 4 scores | N/A | . . . |
| Stage 4 repeat score | N/A | . . . |
| Stage 4 remedial | N/A | . . . |

As seen above, the performance indicator updated at block 555 is inserted in the repeat (i.e. replay) score field rather than as an additional session score. Server 116 may be configured to set a flag or other indicator for any updates at block 555 upon receiving override content identifiers, in order to update a replay score rather than a session score.

A further performance of block 530, in the present embodiment, leads to a further calling of the redirection routine of method 700 (because three sessions have been completed for the current content). In this performance of method 700, the replay score is retrieved at block 705, and the determination at block 710 is affirmative. Therefore, the performance of method 700 proceeds to block 725, at which control is returned to the primary routine of method 500, at block 535. In other words, when the scoring threshold in the redirection routine is met, no override content identifiers are selected. Instead, the default content identifiers are selected—in the present embodiment, since stage 1 is complete, the content identifiers selected at block 535 for transmission to client device 104a are those of stage 2 (see Table 1).

Returning again to FIG. 7, if the determination at block 710 is negative following a replay, the determination at block 715 will be affirmative, and performance of method 700 proceeds to block 730. At block 730, server 116 is configured to determine whether remedial content has been completed by client device 104a for the current content stage. The determination at block 730 is based on the contents of the remedial field in database 246 corresponding to the current content stage. If the field does not contain a flag or score indicating that remedial content has been completed, the determination is negative, and method 700 proceeds to block 735. Otherwise, method 700 proceeds to block 725 (in other words, only one instance of remedial content is required; after one instance of remedial content, client device 104a will be permitted to advance to the next default stage).

At block 735, override content identifiers corresponding to a remedial content stage are selected and returned to the primary routine at block 540. The remedial content identifiers can be selected in a variety of ways. For example, database 242 can contain a remedial stage record that, as with the stage records shown above, specifies content identifiers. In other embodiments, a distinct remedial stage record can be included for each regular stage record. In further embodiments, certain stage records can be both regular stage records in the default sequence, and also remedial stage records for other stages. For instance, stage 1 may be both the first stage in the sequence and also the remedial stage employed in response to low performance in stage 3.

In still further embodiments, remedial stage records can be dynamically generated rather than explicitly defined in database 242. For example, server 116 can be configured to identify the graphical foreground and audio elements most strongly associated with incorrect answers from client device 104a, and dynamically build a remedial content stage containing those elements.

Thus, server 116, through the performance of methods 500 and 700, can guide client devices 104 through the content stored in local memory at those client devices, thus controlling content playback without being required to stream large volumes of graphical and audio data over network 108.

Variations to the above systems and methods are also contemplated. For example, audio elements may be divided into background and foreground audio elements. In such embodiments, audio elements 308 as described above are more accurately referred to as foreground audio elements. Background audio elements can include audio files for backing soundtracks and the like.

In further variations, method 700 (or an additional redirection routine called either from block 530 or from another decision block in method 500) can include a determination of whether or not client device 104a should be accelerated through the content stages, in addition to the determination (discussed above) of whether client device 104a requires repeated or remedial content. Such a determination can be based, for example, on a determination as to whether the most recent session score exceeds an upper threshold (e.g. 90%). As a result of an acceleration decision, server 116 may select an override content stage that advances through the sequence of stages more quickly than the default sequence.

In some variations to method 700, various thresholds can be employed at block 710. For example, rather than only evaluating the most recent session score, server 116 can evaluate an average (e.g. a weighted average) of the most recent session score and the preceding session score. Separate thresholds can also be applied to the most recent session score and the preceding session score.

The scope of the claims should not be limited by the embodiments set forth in the above examples, but should be given the broadest interpretation consistent with the description as a whole.

We claim:

1. A system for modular content deployment and control, comprising:
a client device including an output device, an input device, and a memory storing:
(i) a plurality of graphical background elements and corresponding background content identifiers;
(ii) a plurality of graphical foreground elements and corresponding foreground content identifiers; and
(iii) a plurality of audio elements and corresponding audio content identifiers;
the client device further including a client processor configured to control the output device to present a subset of the graphical background elements, graphical foreground elements, and audio elements;
a server connected to the client device via a network and including a memory storing:
(i) a plurality of stage records arranged in a sequence, each stage record containing a respective subset of the background content identifiers, the foreground content identifiers and the audio content identifiers;
(ii) a client profile corresponding to the client device, the client profile containing an identifier of a most recent completed one of the stages, and a performance indicator for the most recent completed stage;
the server further including a server processor configured to:
receive a request for content identifiers from the client device;
responsive to receiving the request, select, based on the client profile, one of a default stage record and an override stage record from the plurality of stage records; and
transmit to the client device, via the network, the subset of background content identifiers, foreground content identifiers and audio content identifiers contained in the selected stage record.

2. The system of claim 1, wherein the default stage record immediately follows the most recent completed stage in the sequence.

3. The system of claim 2, wherein the override stage is the most recent completed stage in the sequence.

4. The system of claim 1, the client device further configured to receive input data and send report data representing the input data to the server;
the server further configured to store the report data.

5. The system of claim 4, the report data including a plurality of indications of correctness of the input data; the server configured to generate a score based on the indications of correctness.

6. The system of claim 5, the server further configured to determine whether to select the default stage record or the override stage record by:
comparing the score to a threshold;
when the score exceeds the threshold, selecting the default stage record; and
when the score does not exceed the threshold, selecting the override stage record.

7. The system of claim 1, the server configured to determine whether to select the default stage record or the override stage record by executing a redirection routine.

8. A method in a control server for modular content deployment and control, comprising:
storing, in a memory of the server:
(i) a plurality of stage records arranged in a sequence, each stage record containing a respective subset of background content identifiers, foreground content identifiers and audio content identifiers; the background content identifiers corresponding to graphical background elements stored at a client device, the foreground content identifiers corresponding to graphical foreground elements stored at the client device, and the audio content identifiers corresponding to audio elements stored at the client device;
(ii) a client profile corresponding to the client device, the client profile containing an identifier of a most recent completed one of the stages, and a performance indicator for the most recent completed stage;
at a processor of the server connected to the memory, receiving a request for content identifiers from the client device via a network;
responsive to receiving the request, selecting, based on the client profile, one of a default stage record and an override stage record from the plurality of stage records; and
transmitting to the client device, via the network, the subset of background content identifiers, foreground content identifiers and audio content identifiers contained in the selected stage record.

9. The method of claim 8, wherein the default stage record immediately follows the most recent completed stage in the sequence.

10. The method of claim 9, wherein the override stage is the most recent completed stage in the sequence.

11. The method of claim 8, further comprising:
receiving report data from the client device representing input data received at the client device; and
storing the report data in the client profile.

12. The method of claim 11, the report data including a plurality of indications of correctness of the input data; the method further comprising:
generating a score at the processor based on the indications of correctness.

13. The method of claim 12, further comprising determining whether to select the default stage record or the override stage record by:
comparing the score to a threshold;
when the score exceeds the threshold, selecting the default stage record; and
when the score does not exceed the threshold, selecting the override stage record.

14. The method of claim 8, further comprising determining whether to select the default stage record or the override stage record by executing a redirection routine.

15. A control server, comprising:
a memory storing:
(i) a plurality of stage records arranged in a sequence, each stage record containing a respective subset of background content identifiers, foreground content identifiers and audio content identifiers; the background content identifiers corresponding to graphical background elements stored at a client device, the foreground content identifiers corresponding to graphical foreground elements stored at the client device, and the audio content identifiers corresponding to audio elements stored at the client device;
(ii) a client profile corresponding to the client device, the client profile containing an identifier of a most recent completed one of the stages, and a performance indicator for the most recent completed stage; at a processor of the server connected to the memory, receiving a request for content identifiers from the client device via a network;
a network interface for connecting to the client device via a network; and
a processor configured to:
receive a request for content identifiers from the client device;
responsive to receiving the request, select, based on the client profile, one of a default stage record and an override stage record from the plurality of stage records; and
transmit to the client device, via the network, the subset of background content identifiers, foreground content identifiers and audio content identifiers contained in the selected stage record.

16. The control server of claim 15, wherein the default stage record immediately follows the most recent completed stage in the sequence.

17. The control server of claim 16, wherein the override stage is the most recent completed stage in the sequence.

18. The control server of claim 15, the processor further configured to:
receive report data from the client device representing input data received at the client device; and
storing the report data in the client profile.

19. The control server of claim 18, the report data including a plurality of indications of correctness of the input data; the processor configured to generate a score based on the indications of correctness.

20. The control server of claim 19, the processor further configured to determine whether to select the default stage record or the override stage record by:
comparing the score to a threshold;
when the score exceeds the threshold, selecting the default stage record; and
when the score does not exceed the threshold, selecting the override stage record.
